(19) United States
(12) Patent Application Publication
(10) Pub. No.: US 2025/0332975 A1
(43) Pub. Date: Oct. 30, 2025

(54) SWIVEL DEVICE FOR VEHICLE SEAT

(71) Applicant: Hyundai Transys Inc., Seosan-si (KR)

(72) Inventors: Won KIM, Hwaseong-si (KR); Heejun PARK, Hwaseong-si (KR); HEOUNG SU LIM, Hwaseong-si, Gyeonggi-do (KR); SEUNG HUN CHANG, Hwaseong-si (KR); JAE YONG JANG, Hwaseong-si (KR); Soo Young CHAE, Hwaseong-si (KR)

(21) Appl. No.: 19/097,928

(22) Filed: Apr. 2, 2025

(30) Foreign Application Priority Data
Apr. 26, 2024 (KR) 10-2024-0056161

(51) Int. Cl. B60N 2/90; B60N 2/14

(52) U.S. Cl. CPC B60N 2/90; B60N 2/14; B60N 2/938

(57) ABSTRACT

A swivel device for a vehicle seat includes a brake drum inserted into an accommodation portion formed between an inner rim and an outer rim provided on one surface of a housing, the brake drum having accommodation grooves along an inner-diameter portion thereof, and brake members arranged along a space between the inner rim of the housing and the inner-diameter portion of the brake drum.

### CROSS-REFERENCE TO RELATED APPLICATIONS

This application claims priority to and the benefit of Korean Patent Application No. 10-2024-0056161 filed in the Korean Intellectual Property Office on Apr. 26, 2024, the entire contents of which are incorporated herein by reference.

### TECHNICAL FIELD

The present invention relates to a swivel device for a vehicle seat.

### BACKGROUND ART

In general, vehicle seats may be equipped with various types of convenience devices to provide passengers with comfortable ride quality and convenience. Examples of the convenience devices of the vehicle seats may include a seat track device configured to move a vehicle seat forward or rearward to suit an occupant's body type, a leg rest configured to support a passenger's leg, and a swivel device for a vehicle seat configured to rotate a vehicle seat.

The swivel device for a vehicle seat in the related art may include a motor, and a rotation part connected to the vehicle seat. A pinion gear of the motor may engage with a ring gear of the rotation part. When the motor operates, power of the motor may be transmitted to the rotation part, such that the vehicle seat may rotate.

However, in the case of the swivel device for a vehicle seat in the related art, there may occur problems such as operational sensitivity deterioration, clearances, and abnormal sounds caused by influences of accumulated tolerance, dimension precision, gear backlash, and the like. In particular, the clearance between the gears may be a factor that degrades the stability of the vehicle seat.

### Document of Related Art

### Patent Document

(Patent Document 1) Korean Patent Application Laid-Open No. 10-2020-0078903 (published on Jul. 2, 2020)

### SUMMARY OF THE INVENTION

The present invention has been made in an effort to provide a swivel device for a vehicle seat that may improve operational sensitivity by positioning a separate drive module between a fixing part and a rotation part of a swivel, improve stability of a stationary state by removing a clearance caused by an external force, and implement a rotational operation with stable, excellent sensitivity by solving a problem of a sensitivity deviation, which occurs in accordance with a degree to which teeth engage with each other by means of an operation mechanism that adopts a method of coupling gears in the related art, and solving a problem of a deterioration in stability caused by a clearance between a motor and a gear.

In order to achieve the above-mentioned object, the present invention provides a swivel device for a vehicle seat, the swivel device including: a brake drum inserted into an accommodation portion formed between an inner rim and an outer rim provided on one surface of a housing, the brake drum having accommodation grooves along an inner-diameter portion thereof; and brake members arranged along a space between the inner rim of the housing and the inner-diameter portion of the brake drum.

In addition, the brake member may include: an elastic member; and rollers provided at two opposite sides of the elastic member and positioned in the accommodation grooves.

In addition, a clutch drum may be coupled to an upper portion of the housing, and the clutch drum may include: a hub inserted into an inner-diameter portion of the inner rim; pressing protrusions provided along a periphery of the hub and positioned between the brake members to press the rollers; and a second gear part provided on an inner-diameter portion of the clutch drum and configured to engage with a first gear part of a motor.

In addition, a first cover may be seated on an upper portion of a rim portion and an upper portion of the outer rim in a state in which the rim portion provided along a periphery of the brake drum is inserted into the accommodation portion.

In addition, the clutch drum may be surrounded by a second cover, and an edge of the second cover may be coupled to an upper portion of the brake drum.

In addition, a rotation bracket may be coupled to the second cover, and the rotation bracket may include: a main body seated on an edge of the second cover; and an extension portion extending from the main body and coupled to a swivel plate.

In addition, a seat may be seated on the swivel plate.

In addition, the motor may be supported by a support frame, and the first gear part may penetrate the support frame and engage with the second gear part.

In addition, a width between the accommodation groove and the inner rim may decrease toward the pressing protrusion from two opposite ends of the accommodation groove so that the roller is fitted, and the width may increase toward the two opposite ends of the accommodation groove from two opposite ends of the pressing protrusion so that the roller is released.

In addition, the second cover may be coupled to the brake drum by bolting, the main body of the rotation bracket may be coupled by bolting simultaneously with the edge of the second cover and the brake drum in a state in which the main body is seated on the edge of the second cover, and the extension portion of the rotation bracket may be coupled to the swivel plate by bolting.

In addition, two opposite ends of the pressing protrusion may be configured as curved surfaces that conform to the rollers.

According to the present invention, the brake drum rotates in the state in which the brake drum is assembled in the accommodation portion of the housing, such that the brake drum may stably rotate without being warped by an external force.

In addition, the present invention may provide comfort to passengers in the vehicle.

In addition, according to the present invention, the shape of the brake drum is simplified in comparison with a brake drum in the related art, such that it is possible to improve the mass production and manageability of the product.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view illustrating a swivel device for a vehicle seat according to an exemplary embodiment of the present invention.

FIG. 2 is an exploded perspective view of the swivel device for a vehicle seat according to the exemplary embodiment of the present invention.

FIG. 3 is a cross-sectional side view of the swivel device for a vehicle seat according to the exemplary embodiment of the present invention.

FIG. 4 is a view illustrating a state in which a roller of a brake member according to the exemplary embodiment of the present invention is pressed by a pressing protrusion.

FIG. 5 is a view illustrating an operation of the swivel device for a vehicle seat according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. In addition, in the description of the present invention, the specific descriptions of publicly known related configurations or functions will be omitted when it is determined that the specific descriptions may obscure the subject matter of the present invention. Further, the exemplary embodiments of the present invention will be described below, but the technical spirit of the present invention is not limited thereto and may, of course, be modified and variously carried out by those skilled in the art.

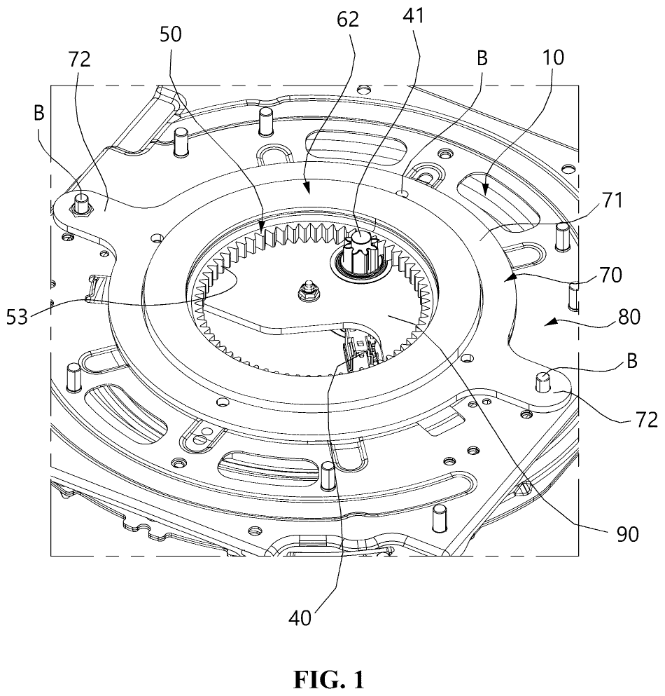

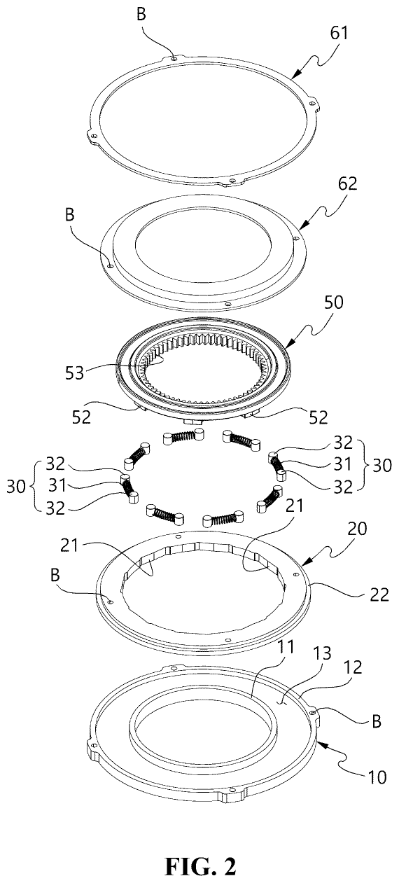

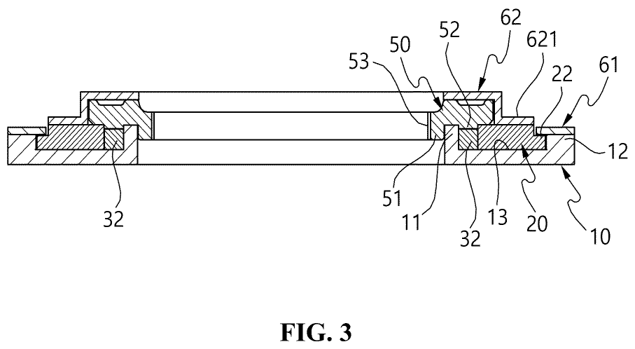

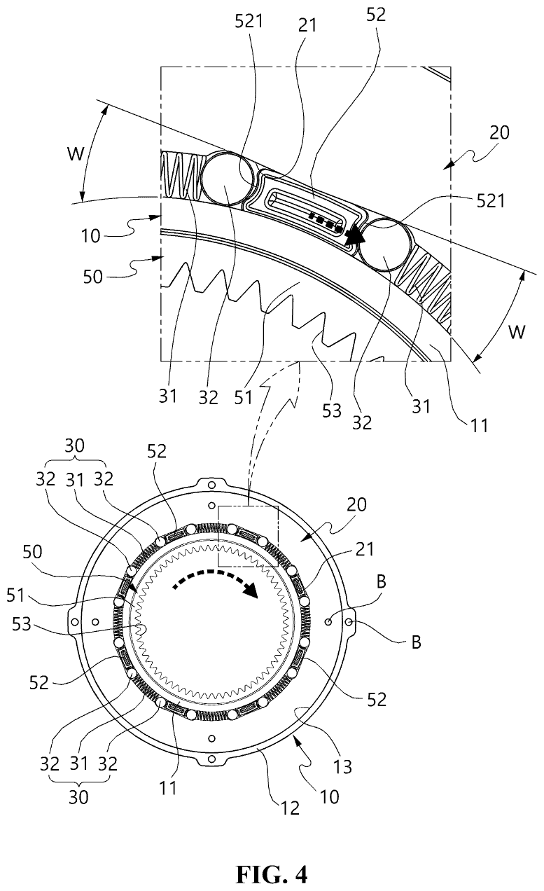

FIG. 1 is a perspective view illustrating a swivel device for a vehicle seat according to an exemplary embodiment of the present invention, FIG. 2 is an exploded perspective view of the swivel device for a vehicle seat according to the exemplary embodiment of the present invention, FIG. 3 is a cross-sectional side view of the swivel device for a vehicle seat according to the exemplary embodiment of the present invention, and FIG. 4 is a view illustrating a state in which a roller of a brake member according to the exemplary embodiment of the present invention is pressed by a pressing protrusion.

As illustrated in FIGS. 1 to 4, a swivel device for a vehicle seat of the present invention may include a brake drum 20 inserted and assembled into an accommodation portion 13 of a housing 10, and brake members 30 arranged along a space between an inner rim 11 of the housing 10 and an inner-diameter portion of the brake drum 20.

As described above, the brake members 30 rotate in the state in which the brake members 30 are inserted into the accommodation portion 13. Therefore, the brake members 30 may stably rotate without being warped by an external force.

The inner rim 11 and an outer rim 12 may be provided on one surface of the housing 10. The accommodation portion 13 may be formed between the inner rim 11 and the outer rim 12.

The brake drum 20 may be configured in a ring shape and include accommodation grooves 21 and a rim portion 22.

The accommodation grooves 21 may be provided along the inner-diameter portion of the brake drum 20.

The brake members 30 may be arranged at predetermined intervals along the space between the inner rim 11 of the housing 10 and the inner-diameter portion of the brake drum 20 in the state in which the brake drum 20 is inserted into the accommodation portion 13 of the housing 10.

The brake member 30 may include an elastic member 31 and rollers 32. For example, the elastic member 31 may be a coiled spring.

The rollers 32 may be provided at two opposite sides of the elastic member 31. The rollers 32 may be positioned in the accommodation groove 21.

A clutch drum 50 may be coupled to an upper portion of the housing 10. The clutch drum 50 may include a hub 51, pressing protrusions 52, and a second gear part 53 configured to engage with a first gear part 41 of a motor 40.

An outer-diameter portion of the hub 51 may be configured to conform to an inner-diameter portion of the inner rim 11. The hub 51 may be inserted and assembled into the inner-diameter portion of the inner rim 11.

The pressing protrusions 52 may be provided at predetermined intervals along a periphery of the hub 51.

The pressing protrusions 52 may be positioned between the brake members 30 to press the rollers 32 of the brake members 30.

Two opposite ends of the pressing protrusion 52 may be configured as curved surfaces 521 that conform to the rollers 32 of the brake member 30.

The second gear part 53, which engages with the first gear part 41 of the motor 40, may be provided along an inner-diameter portion of the clutch drum 50.

For example, the first gear part 41 of the motor 40 may be a pinion gear.

The clutch drum 50 may rotate as power of the motor 40 is transmitted to the second gear part 53 via the first gear part 41.

The motor 40 may be stably supported by a support frame 90. The first gear part 41 may penetrate the support frame 90 and engage with the second gear part 53.

A first cover 61 may be seated on an upper portion of the rim portion 22 and an upper portion of the outer rim 12 in the state in which the rim portion 22 provided along a periphery of the brake drum 20 is inserted into the accommodation portion 13 of the housing 10.

The first cover 61 may be coupled to the housing 10 by bolting B.

As described above, because the first cover 61 blocks an upper side of the rim portion 22 of the brake drum 20, it is possible to prevent a withdrawal of the brake drum 20 inserted into the accommodation portion 13 of the housing 10. Therefore, the brake drum 20 may stably rotate in the state in which the brake drum 20 is inserted into the accommodation portion 13.

The clutch drum 50 may be surrounded by a second cover 62. An edge 621 of the second cover 62 may be coupled to an upper portion of the brake drum 20 by bolting B.

A rotation bracket 70 may be coupled to the second cover 62. The rotation bracket 70 may include a main body 71 and extension portions 72.

The main body 71 may be coupled by bolting B simultaneously with the edge 621 of the second cover 62 and the brake drum 20 in the state in which the main body 71 is seated on the edge 621 of the second cover 62.

The extension portions 72 may extend from the main body 71. The extension portions 72 may be provided as a plurality of extension portions 72 provided on the main body 71. The extension portions 72 may be coupled to a swivel plate 80 by bolting B.

A seat (not illustrated) may be seated on the swivel plate 80. For example, the seat (not illustrated) may be coupled to the swivel plate 80 by bolting or the like.

With reference to FIG. 4, a width W between the accommodation groove 21 of the brake drum 20 and the inner rim 11 of the housing 10 may decrease toward the pressing protrusion 52 of the clutch drum 50 from two opposite ends of the accommodation groove 21 so that the rollers 32 may be fitted.

The width W between the accommodation groove 21 of the brake drum 20 and the inner rim 11 of the housing 10 may increase toward the two opposite ends of the accommodation groove 21 from the two opposite ends of the pressing protrusion 52 of the clutch drum 50 so that the rollers 32 may be released.

Next, an operation of the swivel device for a vehicle seat according to the present invention will be described.

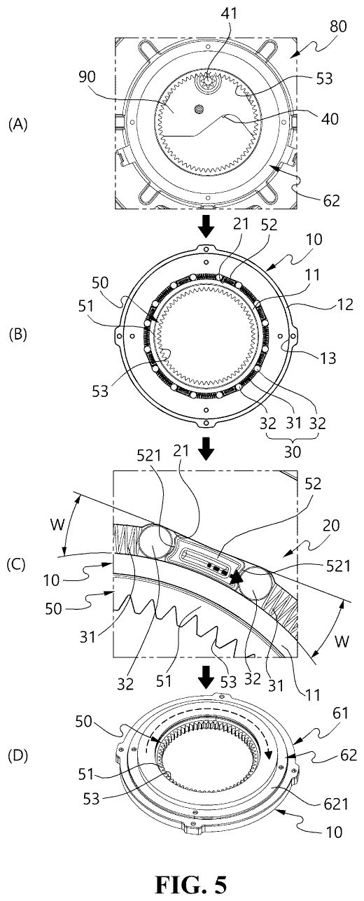

FIG. 5 is a view illustrating the operation of the swivel device for a vehicle seat according to the exemplary embodiment of the present invention.

As illustrated in FIG. 5A, the first gear part 41 may be rotated by an operation of the motor 40.

As illustrated in FIG. 5B, the second gear part 53, which engages with the first gear part 41, may rotate as the first gear part 41 rotates.

The clutch drum 50 inserted into the accommodation portion 13 of the housing 10 may rotate as the second gear part 53 rotates.

As illustrated in FIG. 5C, the pressing protrusion 52 of the clutch drum 50 may press the roller 32 of the brake member 30 at one side as the clutch drum 50 rotates.

The roller 32 of the brake member 30 at one side may be pushed by the pressing protrusion 52 and positioned at one end of the accommodation groove 21.

When the pressing protrusion 52 further presses the roller 32 in the state in which the roller 32 is positioned at one end of the accommodation groove 21, the brake drum 20 may rotate.

As illustrated in FIG. 5D, the second cover 62, which is coupled to the brake drum 20 by bolting B, may rotate as the brake drum 20 rotates.

The rotation bracket 70, which is coupled simultaneously with the edge 621 of the second cover 62 and the brake drum 20 by bolting B, may rotate as the second cover 62 rotates.

The swivel plate 80, which is coupled to the rotation bracket 70 by bolting B, may rotate as the rotation bracket 70 rotates.

The seat (not illustrated) seated on the swivel plate 80 may rotate as the swivel plate 80 rotates.

Meanwhile, in case that the rollers 32 of the brake members 30 are moved by an external force in a reverse direction, i.e., in a direction toward the pressing protrusions 52, the rollers 32 are fitted between the inner rim 11 of the housing 10 and the accommodation grooves 21 of the brake drum 20, such that the rotation of the brake drum 20 may be restricted. Therefore, it is possible to prevent the reverse rotation of the brake drum 20.

As described above, according to the present invention, the brake drum rotates in the state in which the brake drum is assembled in the accommodation portion of the housing, such that the brake drum may stably rotate without being warped by an external force. In addition, the present invention may provide comfort to passengers in the vehicle. In addition, according to the present invention, the shape of the brake drum is simplified in comparison with a brake drum in the related art, such that it is possible to improve the mass production and manageability of the product.

The above description is simply given for illustratively describing the technical spirit of the present invention, and those skilled in the art to which the present invention pertains will appreciate that various modifications, changes, and substitutions are possible without departing from the essential characteristics of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

### DESCRIPTION OF REFERENCE NUMERALS

10: Housing
11: Inner rim
12: Outer rim
13: Accommodation portion
20: Brake drum
21: Accommodation groove
22: Rim portion
30: Brake member
31: Elastic member
32: Roller
40: Motor
41: First gear part
50: Clutch drum
51: Hub
52: Pressing protrusion
521: Curved surface
53: Second gear part
61: First cover
62: Second cover
621: Edge
70: Rotation bracket
71: Main body
72: Extension portion
80: Swivel plate

What is claimed is:

1. A swivel device for a vehicle seat, the swivel device comprising:
a brake drum inserted into an accommodation portion defined between an inner rim and an outer rim positioned on one surface of a housing, the brake drum having accommodation grooves along an inner-diameter portion thereof; and
brake members arranged along a space between the inner rim of the housing and the inner-diameter portion of the brake drum.

2. The swivel device of claim 1,
wherein each of the brake members comprises:
an elastic member; and
rollers disposed at two opposite sides of the elastic member and positioned in the accommodation grooves.

3. The swivel device of claim 2, further comprising:
a clutch drum coupled to an upper portion of the housing,
wherein the clutch drum comprises:
a hub inserted into an inner-diameter portion of the inner rim;
pressing protrusions positioned along a periphery of the hub and positioned between the brake members to press the rollers; and
a second gear part positioned on an inner-diameter portion of the clutch drum and configured to engage with a first gear part of a motor.

4. The swivel device of claim 3, further comprising:
a first cover,
wherein the first cover is seated on an upper portion of a rim portion of the brake drum and an upper portion of the outer rim of the housing in a state in which the rim portion positioned along a periphery of the brake drum is inserted into the accommodation portion.

5. The swivel device of claim 3, wherein the clutch drum is surrounded by a second cover, and an edge of the second cover is coupled to an upper portion of the brake drum.

6. The swivel device of claim 5, further comprising:
a rotation bracket coupled to the second cover,
wherein the rotation bracket comprises:
a main body seated on the edge of the second cover; and
an extension portion extending from the main body and coupled to a swivel plate.

7. The swivel device of claim 6, wherein a seat is seated on the swivel plate.

8. The swivel device of claim 3, wherein the motor is supported by a support frame, and the first gear part of the motor penetrates the support frame to engage with the second gear part.

9. The swivel device of claim 3, wherein a width between each of the accommodation grooves and the inner rim decreases toward corresponding each of the pressing protrusions from two opposite ends of each of the accommodation grooves to allow corresponding each of the rollers to be fitted, and the width increases toward the two opposite ends of each of the accommodation grooves from two opposite ends of corresponding each of the pressing protrusions to allow corresponding each of the rollers to be released.

10. The swivel device of claim 6, wherein the second cover is coupled to the brake drum by bolting, the main body of the rotation bracket is coupled by bolting simultaneously with the edge of the second cover and the brake drum in a state in which the main body is seated on the edge of the second cover, and the extension portion of the rotation bracket is coupled to the swivel plate by bolting.

11. The swivel device of claim 3, wherein two opposite ends of each of the pressing protrusions are configured as curved surfaces that conform to the rollers.
